(19) United States
(12) Patent Application Publication
(10) Pub. No.: US 2018/0245879 A1
(43) Pub. Date: Aug. 30, 2018

(54) Protective Cap

(71) Applicant: Leica Camera AG, Wetzlar (DE)

(72) Inventors: Sven Roman MUELLER, Butzbach (DE); Marcus KUCHLER, Muenchen (DE)

(21) Appl. No.: 15/905,090

(22) Filed: Feb. 26, 2018

(30) Foreign Application Priority Data
Feb. 27, 2017 (DE) 10 2017 104 083.8

(51) Int. Cl. F41G 1/38

(52) U.S. Cl. CPC F41G 1/383; E05D 3/02

(57) ABSTRACT

A protective cap for cylindrically mounted optical elements includes a retaining ring which is placed on a cylinder ring so as to be rotatable. The retaining ring covers the circumferential surface of the cylinder ring in a form-fitting manner. A latching mechanism having a latching element which engages in the latching mechanism in a force-fitting or form-fitting manner is present between the cylinder ring and retaining ring. The latching element is releaseable by an actuating element which is mounted on the retaining ring. A folding hinge for fastening and moving a protective cover from a covering position into a spatially fixed open position is present on the retaining ring.

### CROSS REFERENCE TO RELATED APPLICATIONS

This application claims priority under 35 U.S.C. § 119 from German Patent Application No. 10 2017 104 083.8, filed Feb. 27, 2017, the entire disclosure of which is herein expressly incorporated by reference.

### BACKGROUND

The embodiments of the invention relate to a protective cap for cylindrically mounted optical elements, in particular eyepieces or objectives on telescopes.

Objective mountings may be provided on the front side with an internal thread into which filters or diaphragms provided with an external thread can be screwed. DE 10 2006 036 890 B4 discloses cylinder rings which allow accessory parts to be received such that they are oriented in a rotationally secure manner.

Protective caps for objectives may also have a wide variety of designs. The protective caps are either pushed directly onto an objective tube or held on a retaining ring pushed onto the objective tube.

DE 20 2015 102 076 U1 discloses a retaining ring which has retaining eyes which are mounted in an oriented manner and into which a protective cover can be inserted by means of a flexible lug. The orientation of the retaining eye is for example such that, after being released from the objective, the protective cover hangs freely downward on the retaining ring and does not hinder the view through the objective. The protective cover can be securely inserted in a positionally fixed manner and for protection against environmental influences into the objective mounting by means of an annular bead which is placed under radial tension by an annular spring.

The protective covers are usually produced from a flexible plastic or rubber.

For use on telescopes, in particular on telescopic sights mounted on a weapon, a downwardly hanging protective cover is obstructive because, given that it rests movably on the weapon, it can hinder the view through the objective or limits the distance between the eyepiece and the eye of the user.

In the case of telescopic sights on hunting weapons, protective covers made of plastic or rubber entail the risk that, when the weapons are being carried in hunting grounds, said covers can be damaged or penetrated by branches, with the result that the front lens of the telescope objective can be damaged.

### SUMMARY

The inventive protective cover mounted on a retaining ring may be fastened in such a way that, after being released from its protective function, it can be brought into radially different, stable, in particular impact-secured, rest positions. In addition, the protective cover offers secure protection against penetration.

The protective cap comprises two ring elements of which the outer covers the inner in a form-fitting manner and is rotatable thereon. For use of the protective cap, the inner cylinder ring is screwed into the front-side opening of the cylindrical mounting of an optical element. The outer ring element is provided as a retaining ring with a folding hinge for fastening and moving the protective cover from a position for covering the optical element into an open position.

In order to be able to firmly screw the protective cap into a cylindrical mounting of an optical element, a latching mechanism is present between the outer retaining ring and the inner cylinder ring. Releasing this latching mechanism allows the retaining ring to be brought into an orientation with respect to the cylinder ring in which the folding hinge bearing the protective cap holds the protective cap in the open position in the desired rest position.

In order to screw the cylinder ring into the cylindrical mounting of an optical element, the cylinder ring is provided with an external thread which, when firmly seated in the cylindrical mounting, must not hinder the rotatability of the retaining ring. This may be achieved by limiting the screwing-in depth through adaptation between the length of the external thread and the thread depth on the cylindrical mounting.

To compensate for tolerances between the two stated dimensions, the external thread may be provided in the root region with an undercut into which there may be inserted an O ring as a squeezing element which, on the one hand, allows a firm seating in the screw-in thread and, on the other hand, limits the space between the edge of the cylindrical mounting and the retaining ring only to the extent that the rotatability of the latter is not hindered.

The latching mechanism between the cylinder ring and the retaining ring comprises toothing mounted on the outer circumference of the cylinder ring and a latching element which, as a latching block, is formed with tooth elements which engage in the toothing in a force-fitting or form-fitting manner.

The toothing preferably takes the form of rectangular toothing which allows a form-fitting engagement of the likewise rectangular latching elements of the latching block in the toothing on the cylinder ring, thereby ensuring a play-free rotation of the protective cap upon screwing into the cylindrical mounting of the optical element to be protected.

The latching mechanism may be released manually. For this purpose, an actuating element is preferably present on the folding hinge. The actuating element can comprise a plunger which is displaceable tangentially to the retaining ring counter to a spring pretensioning, and thereby lifts the tooth elements of the latching block out of the toothing on the cylinder ring. Upon release of the actuating element, the tooth elements of the latching block automatically spring into the toothing on the cylinder ring and secure the selected rotary position of the retaining ring. Alternatively, instead of the plunger arrangement, a tilting lever for lifting the latching block may also be present.

The protective cover is pivotable about a pivot pin on the folding hinge. This pivot pin may be fastened to the folding hinge in the front region of the attached protective cap, i.e. above the front side of the cylinder ring and retaining ring or somewhat set back, i.e. in the direction above the external thread. The somewhat set back arrangement with respect to the front side allows a more pleasing design of the overall arrangement and, owing to the angular position of the pivot pin with respect to the covering position, this set back arrangement also allows for better securing against unintentional folding-away of the protective cover.

When rotating the protective cover about the pivot pin, the latter may interact with a tensionable leg spring. Upon closing the optical elements, said leg spring supports the covering position of the protective cover. On the other hand, a certain degree of friction may be present in the mounting of the pivot pin, this friction counteracts the tension of the leg spring and allows the protective cover to rest in any desired pivoted position.

Particularly, when using the protective cap for protecting the optical front elements of telescopic sights and the eye of the person taking aim, the position of the pivoted-out protective cover also remains unchanged upon recoil on a weapon. For this purpose, there may be arranged at least one magnet on the folding hinge and/or a magnet on the protective cover such that they secure the pivoted position through their magnetic force. A pivoted position is preferably chosen in which the protective cover in the open position lies parallel to the optical axis of the optical element to be protected.

A secure covering position of the protective cover may also be provided. For this purpose, a further ring element may be inserted on the front side into the cylinder ring or the retaining ring, which ring element may consist either of a deformable plastic, rubber, or of metal. Here, the further ring element is intended to project with respect to the cylinder ring and/or retaining ring, and to have a deformable bead on its exposed outer circumference. Said bead can be formed either by the plastic of the further ring or by an inserted O ring.

Here, the protective cover is expediently formed with a pot-shaped edge in the interior of which a groove adapted to the bead is incorporated. The groove depth may be designed to decrease starting from the folding hinge, the depth being less than the bead height at the shallowest point. During engagement between the groove and bead, the pot-shaped edge of the protective cover is braced with respect to its pivot pin, and thus securely held in the covering position. Further, one or more clips which engage around the retaining ring can be integrally formed on the pot-shaped edge of the protective cover.

Exemplary embodiments of the inventive protective cap are schematically illustrated in the drawings and are described in more detail below with reference to the figures, in which:

### BRIEF DESCRIPTION OF THE DRAWINGS

FIG. 1 shows a cross section through the protective cap with set-back pivot pin,

FIG. 2 shows a cross section with front-side pivot pin,

FIG. 3 shows a cross section with latching mechanism,

FIG. 4 shows a perspective view of the latching mechanism,

FIG. 5 shows a lifting device for actuating the latching mechanism,

FIG. 6 shows the arrangement of a magnet in the folding hinge and cover,

FIG. 7 shows the arrangement of two magnets in the folding hinge,

FIG. 8 shows a cross section with additional ring element on the retaining ring, and

FIG. 9 shows a protective cover with clips for engaging around the retaining ring.

### DETAILED DESCRIPTION OF EMBODIMENTS

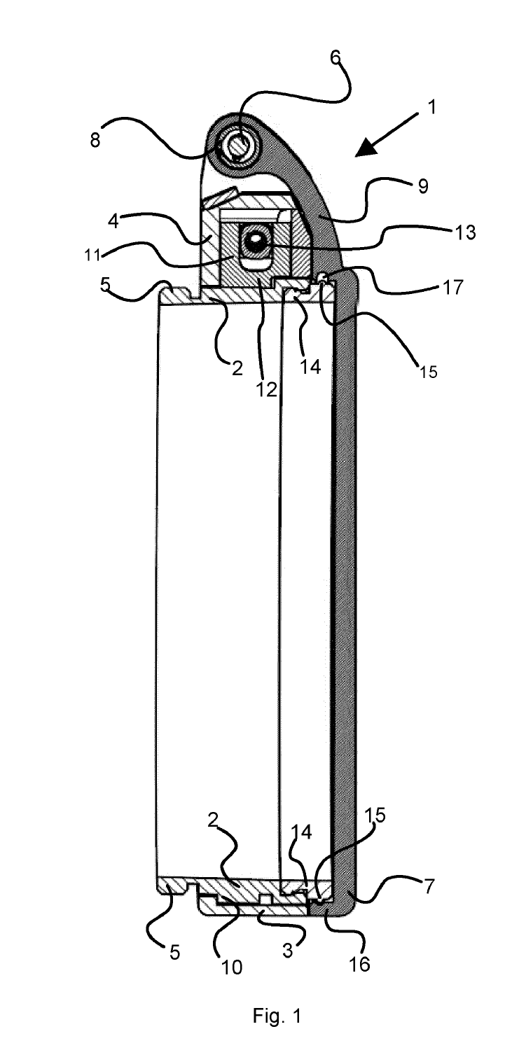

The protective cap 1 illustrated in FIG. 1 comprises an inner cylinder ring 2 and a retaining ring 3 rotatably mounted thereon. A folding hinge 4 is fastened to the retaining ring 3.

The cylinder ring 2 comprises an external thread 5 for screwing into a cylindrical mounting (not shown) of an optical element to be protected. The length of the external thread 5 is chosen such that, in interaction with the screw-in thread of the mounting of the optical element, it does not hinder the rotatability of the retaining ring 3.

The folding hinge 4 comprises a pivot pin 6 which may be set back with respect to the front side of the protective cap 1 with the protective cover 7 in the direction of the external thread 5. The pivot pin 6 interacts with a tensionable leg spring 8 (not shown further).

The bent-off lever region 9 which extends from the pivot pin 6 to the protective cover 7 results, on the one hand, in a stable position of the protective cover 7 in the covering position illustrated and, on the other hand, in a more pleasing appearance of the overall arrangement.

Arranged within the folding hinge 4 is a latching mechanism which comprises toothing 10 present on the outer circumference of the cylinder ring 2 and a latching block 11 with tooth elements 12. The engagement of the tooth elements 12 in the toothing 10 may be released by manual actuation of a plunger 13 in order to bring the retaining ring 3 into a desired rotary position with respect to the cylinder ring 2.

A ring element 14 is screwed into the cylinder ring 2 on the front side. The ring element 14 projects with respect to the front-side end of the cylinder ring 2 and comprises an external circumferential bead 15 in this edge region. The protective cover 7 is provided with a pot-shaped edge 16 in the interior of which a groove 17 is incorporated. In the upper region pointing toward the pivot pin 6, this groove 17 has a greater depth than diametrally opposite in the lower region, the groove depth at the shallowest point being less than the bead height on the ring element. In the state in which it covers the optical element to be protected, the protective cover 7 is therefore clamped in the lower region between the bead 15 and groove 17, with the result that the covering position is secured against unintentional opening. The clamped state may be achieved by powerful folding down of the protective cover 7 or by manual pressure.

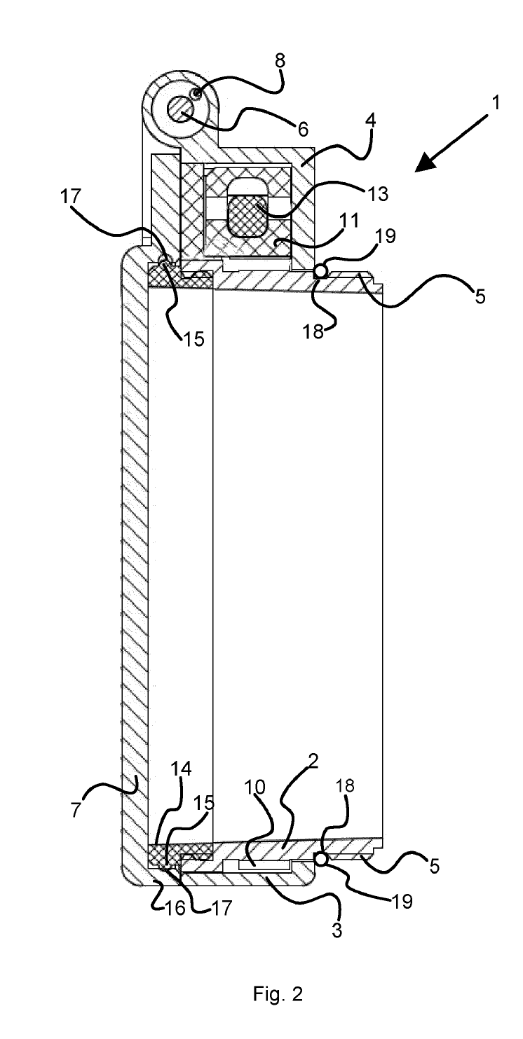

FIG. 2 shows a pivot pin 6 on the folding hinge 4 that is oriented substantially aligned with the direction of the protective cover 7 in the covering state. The region of an undercut 18 on the external thread 5 is filled with an O ring 19 here. When screwing into the cylindrical mounting of an optical element to be protected, said mounting cuts into the O ring 19 or squeezes it against an end region of the retaining ring 3 without adversely affecting the rotatability thereof. The arrangement consisting of the cylinder ring 2 and retaining ring 3 can also be secured against falling apart by the insertion of the O ring 19.

The inner cylinder surface of the cylinder ring 2 and of the ring element 14 are configured so as to be slightly conical toward the outside in order to not constrict the opening angle of the bundle of rays to be received by the optical system to be protected.

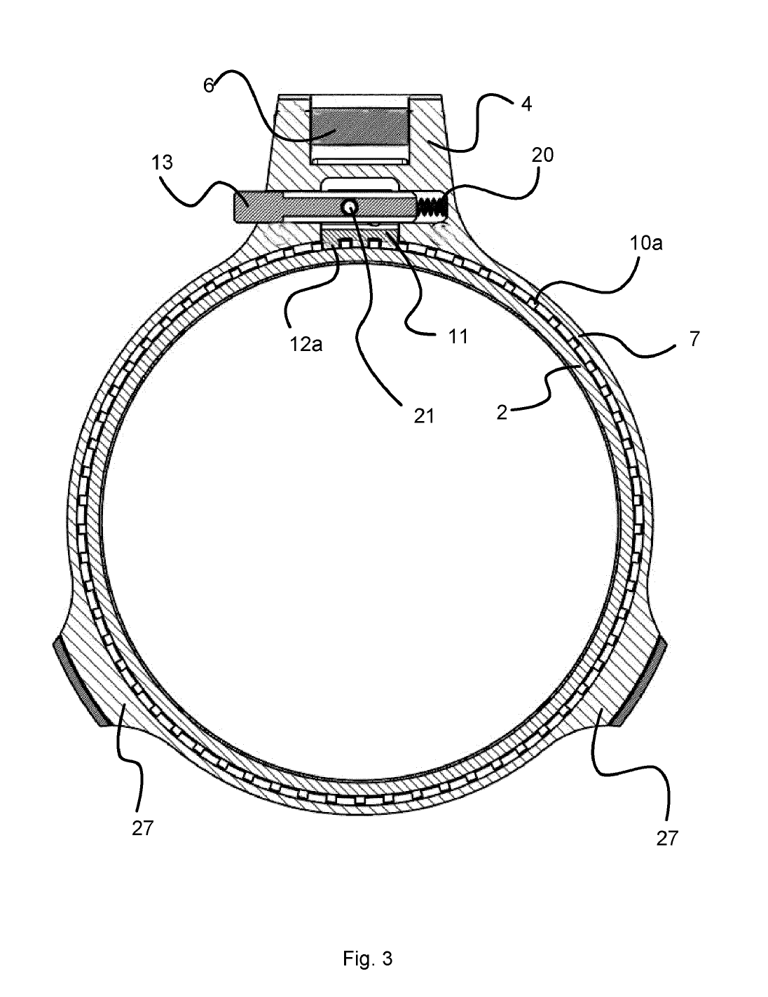

FIG. 3 shows in cross section the rectangular toothing 10a on the outer circumference of the cylinder ring 2. The tooth elements 12a on a latching block 11, which are adapted to the toothing 10a engage in this toothing, and thus fix the relative position between the folding hinge 4 and cylinder ring 2.

The plunger 13 is mounted in the folding hinge 4, so as to be displaceable tangentially to the cylinder ring 2 counter to the pressure of a spring 20. Via a pin 21 which is guided in an oblique slot (not shown here), the plunger 13, when pressed in manually, raises the latching block 11 and lifts the tooth elements 12a out of the rectangular toothing 10a.

Lugs 27 which can be used for manually lifting and pressing the protective cover 7 are integrally formed on the protective cover 7.

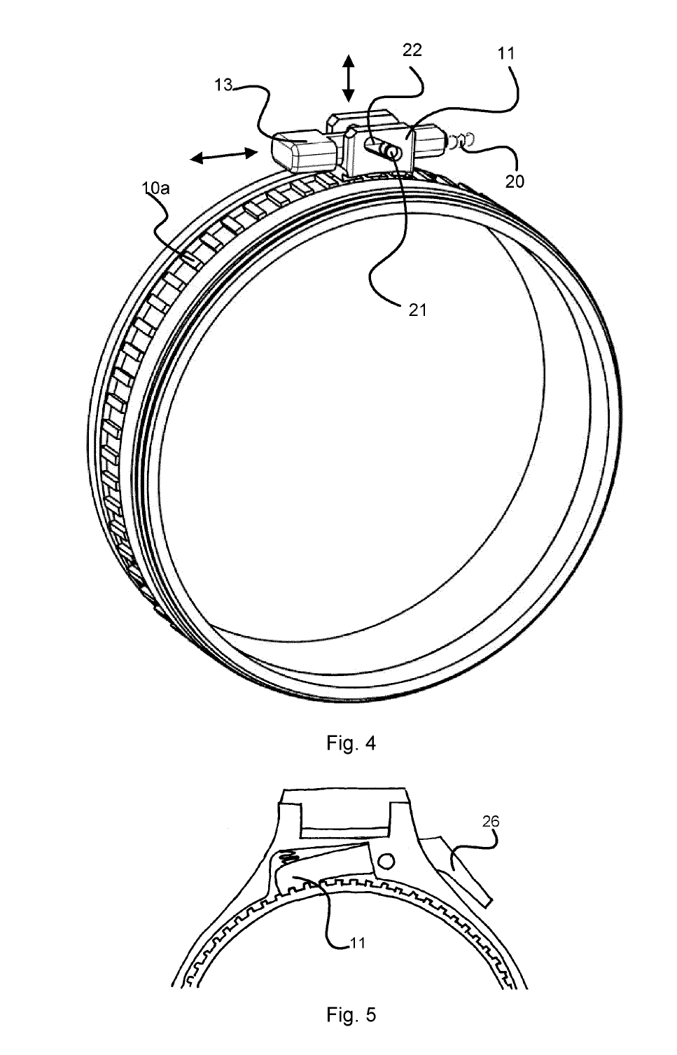

FIG. 4 shows in further detail the function of the plunger mechanism with the oblique slot 22 in which the pin 21 on the plunger 13 is guided.

FIG. 5 shows a lifting device 26 with latching block 11.

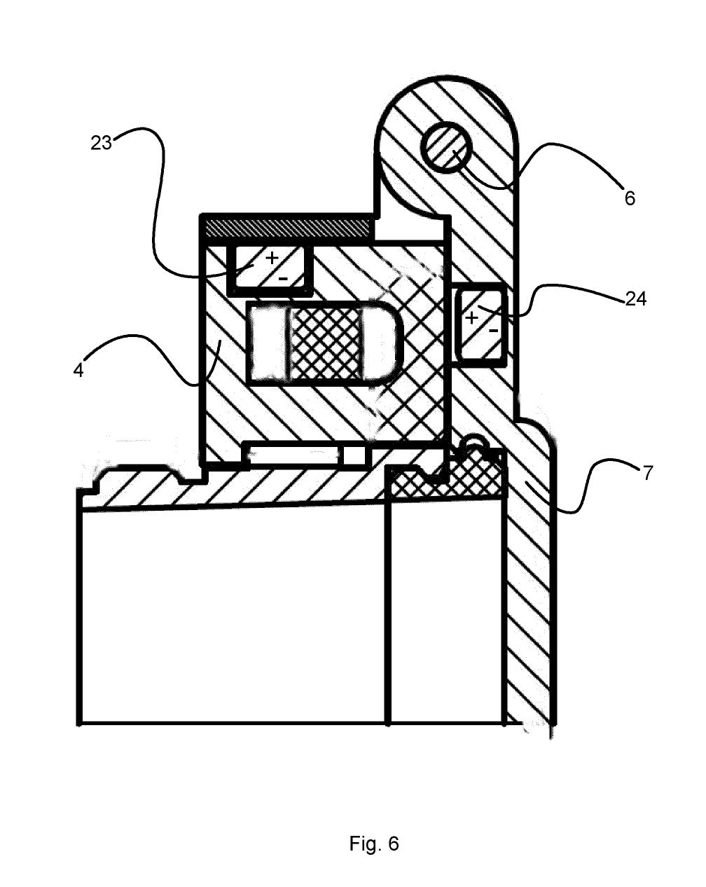

FIG. 6 shows the arrangement of a magnet 23, 24 both in the folding hinge 4 and in the protective cover 7, which attract one another by magnetic force in the folded-open state of the protective cover 7.

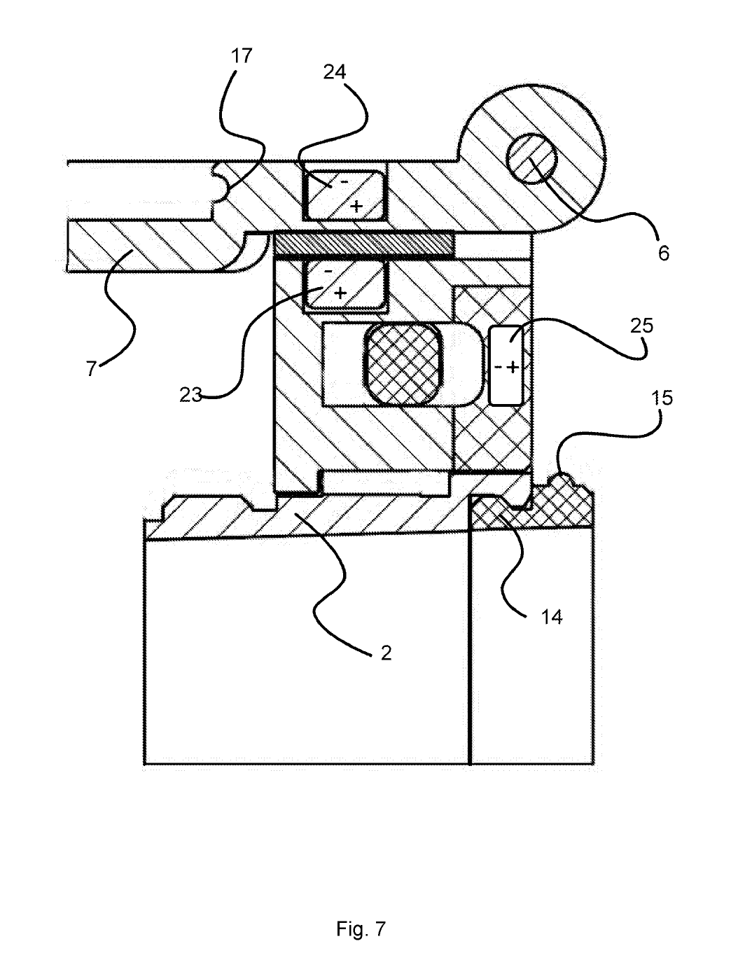

FIG. 7 shows the same arrangement, in which in the folding hinge 4 there is a further magnet 25 which interacts with the magnet 24 in the protective cover 7 in the covering position. In the open position, the protective cover 7 is oriented parallel to the optical axis of the optical system to be protected.

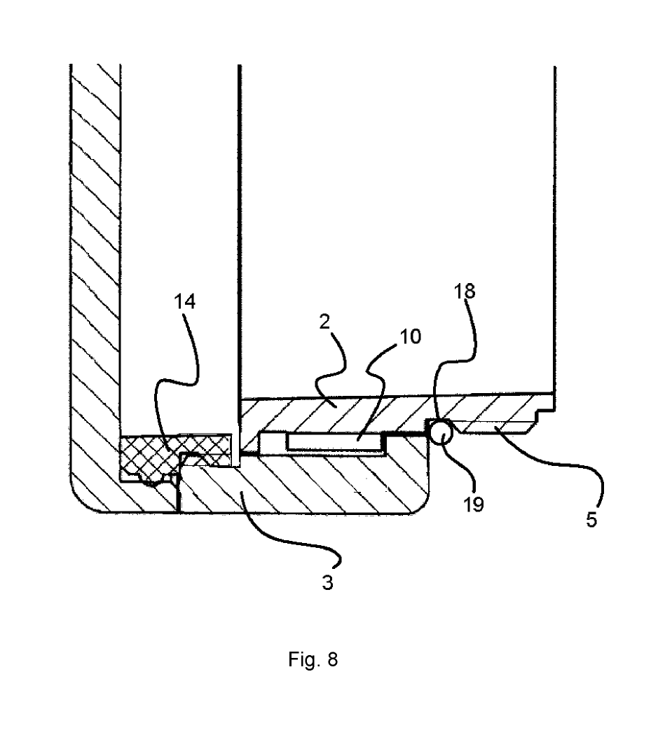

FIG. 8 shows the ring element 14 being screwed into the retaining ring 3. With this configuration, the rotatability of the retaining ring 3 on the cylinder ring 2 may not hindered by the ring element 14. In addition, the retaining ring 3 pushed over the external thread 5 and the toothing 10 are secured by the insertion of an O ring 19 into the undercut 18 against falling apart prior to screwing into the cylindrical mounting of an optical element.

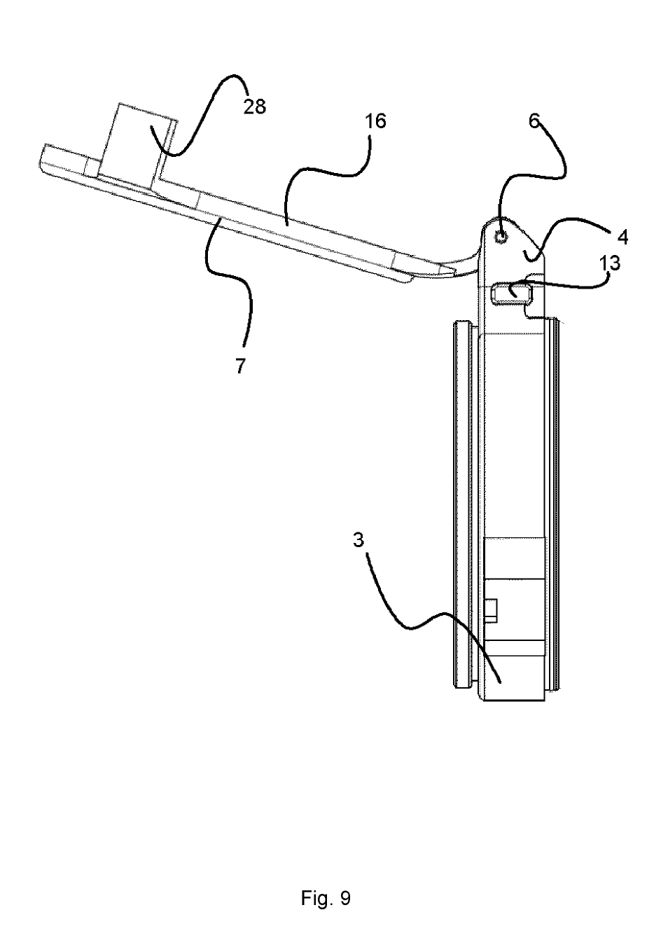

FIG. 9 shows the arrangement of a clip 28 on the pot-shaped edge 16 of the protective cover 7 as an additional securing means for the covering state of the protective cover 7 on the retaining ring 3.

### LIST OF REFERENCE SIGNS

1 Protective cap

2 Cylinder ring

3 Retaining ring

4 Folding hinge

5 External thread

6 Pivot pin on the folding hinge

7 Protective cover

8 Leg spring

9 Pivot pin/protective cover lever

10 Toothing on cylinder ring

10a Rectangular toothing

11 Latching block

12 Tooth elements

12a Rectangular tooth elements

13 Plunger

14 Ring element

15 Bead on ring element

16 Pot-shaped edge

17 Groove in the pot-shaped edge

18 External thread undercut

19 O ring on the external thread

20 Compression spring on the plunger

21 Pin on the plunger

22 Slot in the latching block

23,25 Magnet on the folding hinge

24 Magnet on the protective cover

26 Lifting device

27 Lug on the protective cover

28 Clip on the protective cover

The foregoing disclosure has been set forth merely to illustrate the embodiments of the invention and is not intended to be limiting. Since modifications of the disclosed embodiments incorporating the spirit and substance of the invention may occur to persons skilled in the art, the embodiments of the invention should be construed to include everything within the scope of the appended claims and equivalents thereof.

What is claimed is:

1. A protective cap for cylindrically mounted optical elements, comprising:
a retaining ring which is placed on a cylinder ring so as to be rotatable, wherein
the retaining ring covers the circumferential surface of the cylinder ring in a form-fitting manner,
a latching mechanism having a latching element which engages in the latching mechanism in a force-fitting or form-fitting manner is present between the cylinder ring and retaining ring,
the latching element is releaseable by an actuating element which is mounted on the retaining ring, and
a folding hinge for fastening and moving a protective cover from a covering position into a spatially fixed open position is present on the retaining ring.

2. The protective cap as claimed in claim 1, wherein the cylinder ring has an external thread for screwing into the cylindrical mounting of the optical elements.

3. The protective cap as claimed in claim 2, wherein the length of the external thread is adapted to the screwing-in depth in the cylindrical mounting.

4. The protective cap as claimed in claim 3, wherein the external thread has in the root region an undercut for inserting an O ring which does not hinder the rotatability of the retaining ring.

5. The protective cap as claimed in claim 1, wherein the latching mechanism comprises a toothing mounted on the outer circumference of the cylinder ring and a latching element which, as a latching block, is formed with tooth elements which engage in a force-fitting or form-fitting manner in the gaps of the toothing.

6. The protective cap as claimed in claim 5, wherein the toothing and the tooth elements are rectangular toothing.

7. The protective cap as claimed in claim 1, wherein the latching element is manually actuatable.

8. The protective cap as claimed in claim 1, wherein the latching block and its actuating element are arranged on the folding hinge.

9. The protective cap as claimed in claim 8, wherein the latching block liftable out of the toothing in the radial direction to the cylinder ring by a plunger which is displaceable tangentially to the cylinder ring counter to a compression spring.

10. The protective cap as claimed in claim 9, wherein the latching block is actuatable via a lifting device which is under spring pretensioning.

11. The protective cap as claimed in claim 1, wherein the folding hinge has a pivot pin which is arranged above the front side of the retaining ring.

12. The protective cap as claimed in claim 2, wherein the folding hinge has a pivot pin which is arranged above the end of the retaining ring that points toward the external thread.

13. The protective cap as claimed in claim 12, wherein the pivot pin interacts with a leg spring which is tensionable during the rotation of the folding hinge.

14. The protective cap as claimed in claim 1, wherein the folding hinge comprises at least one magnet which interacts with a magnet arranged in the protective cover so that at least one discrete folding position of the protective cover is maintainable in an impact-secured manner.

15. The protective cap as claimed in claim 1, wherein a ring element is screwed into the front-side opening of the cylinder ring, which ring element consists of deformable plastic and has an edge, which projects with respect to the cylinder ring, with an outwardly pointing circumferential bead, or consists of metal, an O ring as a deformable bead being inserted into the edge.

16. The protective cap as claimed in claim 1, wherein a ring element is screwed into the front-side opening of the retaining ring, which ring element consists of deformable plastic and has an edge, which projects with respect to the retaining ring, with an outwardly pointing circumferential bead, or consists of metal, an O ring as a deformable bead being inserted into the edge.

17. The protective cap as claimed in claim 15, wherein the protective cover is formed with a pot-shaped edge which engages over the ring element and in the interior of which a groove adapted to the bead is incorporated.

18. The protective cap as claimed in claim 17, wherein the groove depth is designed to decrease from the region of the folding hinge to a diametrally opposite region.

19. The protective cap as claimed in claim 18, wherein the groove depth at the shallowest point is less than the bead height on the ring element.

20. The protective cap as claimed in claim 17, wherein at least one clip which engages over the retaining ring is attached to the pot-shaped edge of the protective cover.

21. The protective cap as claimed in claim 16, wherein the protective cover is formed with a pot-shaped edge which engages over the ring element and in the interior of which a groove adapted to the bead is incorporated.

22. The protective cap as claimed in claim 21, wherein the groove depth is designed to decrease from the region of the folding hinge to a diametrally opposite region.

23. The protective cap as claimed in claim 22, wherein the groove depth at the shallowest point is less than the bead height on the ring element.

24. The protective cap as claimed in claim 21, wherein at least one clip which engages over the retaining ring is attached to the pot-shaped edge of the protective cover.
